(19) United States
(12) Patent Application Publication
(10) Pub. No.: US 2008/0229289 A1
(43) Pub. Date: Sep. 18, 2008

(54) Bitmapped Data String Conversions

(75) Inventors: George M. Nauman, Omaha, NE (US); Brent Adkisson, Omaha, NE (US); Francis Patrick Courtney, Omaha, NE (US); Renee Lutzen, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/685,521

(22) Filed: Mar. 13, 2007

(51) Int. Cl. G06F 9/45

(52) U.S. Cl. 717/136

(57) ABSTRACT

A method for converting bitmapped messages in one codeset into a message of another codesets is disclosed. In one step a bitmapped message is parsed into a bitmapped field and a data field. The binary representation of the bitmapped field is used to determine which data elements are present within the data field and the length of the data elements. The data elements may then be converted into a new codeset.

### BACKGROUND OF THE INVENTION

This disclosure relates in general to data string conversions and, but not by way of limitation, to converting a bitmapped data string from one codeset into a data string in another codeset among other things.

Computer systems often rely on specific message formats for communication between networked computers. Various messaging formats are used for inter-computer communications. For example, card-based financial transactions often rely on the ISO 8583 message standard, which uses bitmaps to convey message structure. When codeset conversions occur, however, such as EBCDIC to ASCII, the bitmaps do not translate properly. Consequently, systems using the ASCII version of the message are unable to parse the bitmapped message according to the ISO 8583 standard. Accordingly, a message conversion that accounts for bitmap portions of a message must occur in order for computers using one message codeset to communicate with those using another.

### BRIEF SUMMARY OF THE INVENTION

In one embodiment, the present disclosure provides a computer system for translating a bitmapped data string into a new data string. The bitmapped data string may include a bitmap field and a data field with one or more data elements. The computer system includes an electronic storage, a network adapter, and a processor. The processor includes instructions to parse the bitmap field from the bitmapped data string and instructions to determine from the bitmap field which data elements are present in the data field. The processor also includes instructions to convert each of the at least one data elements into a new data element, instructions to delimit each of the new data elements according to a new data string format associated with the new data string, and instructions to create the new data string with each of the delimited new data elements.

Other embodiments include sending the data string to a network through the network adapter. The bitmapped data string may conform with the ISO 8583 standard. The new data string may be a comma-delimited ASCII data string. The bitmapped data string may be received from a network through a network adapter. The processor may also include instructions to expand the bitmap field into bit representations. The system may also include a field dictionary stored in the electronic storage and the processor includes instructions to lookup a data field length stored in the field dictionary. The field dictionary may also indicate that the data element length is variable and indicate the number of characters in the specific data element used to indicate the data element length. The processor may include instructions to read the data element length from the number of characters in the specific data element, and convert the remainder of the elements into new data elements.

In another embodiment, the invention discloses a method for translating a bitmapped data string into a new data string. The bitmapped data string may comprise a bitmap field and a data field with one or more data elements. The method includes parsing the bitmap field from the bitmapped data string, determining from the bitmap field which of the at least one data elements are present in the data field, converting each of the at least one data elements into a new data element, delimiting each of the new data elements according to a new data string format associated with the new data string, and creating the new data string with each of the delimited new data elements. The embodiment may include expanding the bitmap field into bit representations and/or determining the length of each data element. The method may include looking up data field characteristics in a data field dictionary. Receiving the bitmapped data string prior to removing the bitmap field from the bitmapped data string may also be included. The new data string format may be a comma-delimited ASCII data string. The empty data elements in the bitmapped data string may be translated into empty data fields in a comma-delimited ASCII data string. The bitmapped data string may be an ISO 8583 compliant data string. The new data string may be a data stream.

In yet another embodiment of the invention, the invention discloses a method for translating a data string into a bitmapped data string. The data string may include one or more data elements. The method may include extracting data elements from the data string, looking up in a data field dictionary the bitmap representation for the data element, creating a bitmap field by setting the data bits relating to the data element according to the data field dictionary, converting each of the at least one data elements into a new data element in the format associated with the bitmapped data string, and joining the new data element and the bitmap field. The method may also include receiving the data string. The bitmapped data string may be an ISO 8583 compliant data string. The new data string format may be a comma-delimited ASCII data string.

### BRIEF DESCRIPTION OF THE DRAWINGS

FIG. 1 shows a block diagram of an exemplary computer system for converting bitmapped data strings in one codeset into another codeset, such as an ASCII strings according to one embodiment of the invention.

FIG. 2 shows a hexadecimal bitmapped data string in EBCDIC according to one embodiment of the invention.

FIG. 3 shows an exemplary field dictionary according to one embodiment of the invention.

FIGS. 4A, 4B, 4C, and 4D show ASCII data strings converted from the EBCIDIC bitmapped message in FIG. 2 according to one embodiment of the invention.

FIG. 5 shows a method for converting a bitmapped data string into a new data string according to one embodiment of the invention.

FIG. 6 shows a method for converting a bitmapped data string into a comma-delimited ASCII data string according to one embodiment of the invention.

FIG. 7 shows a method for converting a comma-delimited ASCII string into a bitmapped data string according to one embodiment of the invention.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

In one embodiment, the present disclosure provides a bitmapped data string conversion system. A bitmapped data string includes a bitmap field and data field. The asserted bits in the bitmap field indicate the presence of data elements in the data field. A field dictionary may be referenced to determine various characteristics of the data elements such as the length of the data element or the types of data being converted. For example, an EBCDIC message may be converted into an ASCII string or an XML data element.

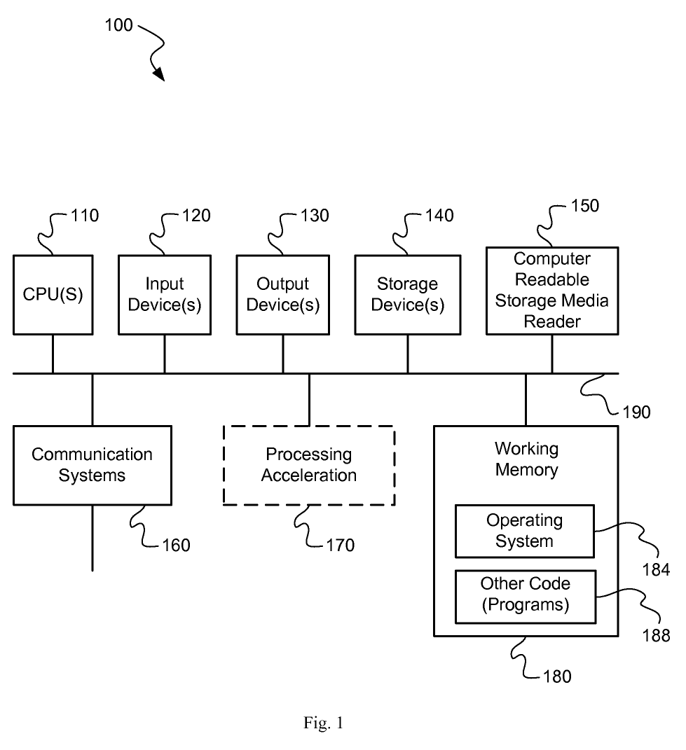

FIG. 1 is a block diagram illustrating an exemplary computer system 100 in which embodiments of the present invention may be implemented. This example illustrates a computer system 100 such as may be used, in whole, in part, or with various modifications, to provide the functions of converting a bitmapped data string in one codeset into a new data string in another codeset. Any type of bitmapped codeset may be translated to another type of codeset. For example, converting an EBCDIC data string to an ASCII data string.

The computer system 100 is shown comprising hardware elements that may be electrically coupled via a bus 190. The hardware elements may include one or more central processing units 110, one or more input devices 120 (e.g., a mouse, a keyboard, etc.), and one or more output devices 130 (e.g., a display device, a printer, etc.). The computer system 100 may also include one or more storage device 140. By way of example, storage device(s) 140 may be disk drives, optical storage devices, solid-state storage devices such as a random access memory (“RAM”) and/or a read-only memory (“ROM”), which can be programmable, flash-updateable and/or the like.

The computer system 100 may additionally include a computer-readable storage media reader 150, a communications system 160 (e.g., a modem, a network card (wireless or wired), an infrared communication device, Blutetooth™ device, cellular communication device, etc.), and working memory 180, which may include RAM and ROM devices as described above. In some embodiments, the computer system 100 may also include a processing acceleration unit 170, which can include a digital signal processor, a special-purpose processor and/or the like.

The computer-readable storage media reader 150 can further be connected to a computer-readable storage medium, together (and, optionally, in combination with storage device(s) 140) comprehensively representing remote, local, fixed, and/or removable storage devices plus storage media for temporarily and/or more permanently containing computer-readable information. The communications system 160 may permit data to be exchanged with a network, system, computer and/or other component described above.

The computer system 100 may also comprise software elements, shown as being currently located within a working memory 180, including an operating system 184 and/or other code 188. It should be appreciated that alternate embodiments of a computer system 100 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

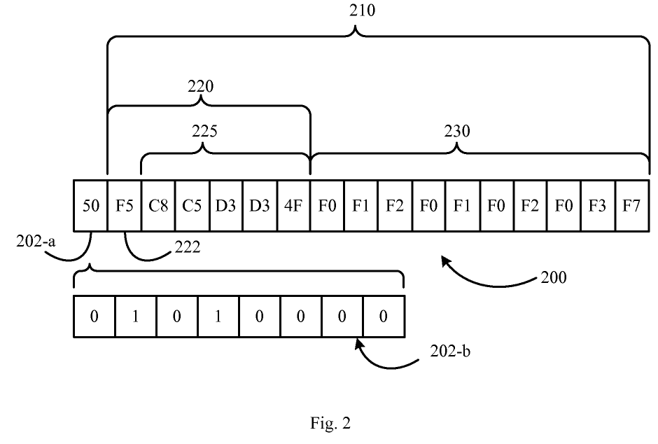

FIG. 2 shows a bitmapped data string 200 according to one embodiment of the invention. In this embodiment, the bitmapped data string 200 includes a bitmap field 202-a and data field 210. The bitmapped data string 200 may be in any format, such as binary, EBCDIC, ASCII, decimal, unicode, etc. In this example, the data field 210 includes two data fields 220, 230. The data string 200 has a single bitmap 202-a with the hexadecimal value “50”. This hexadecimal representation of the bitmap field 202-a may be expressed in binary 202-b as “01010000”. This bit representation, reading from right to left, indicates that data elements 5 and 7 are present in the data field 210. The entire bitmapped data string 200 may not be immediately converted in its entirety, otherwise the bitmap field 202-a becomes improperly altered. For example, if the bitmap 202-a is converted first, the value “50” is an EBCDIC “&”. The “&” in ASCII is represented by “26” in hexadecimal. Accordingly, an EBCDIC to ASCII conversion would result in a hexadecimal “26 as the value for the bitmap field 202-a”. The binary representation of a hexadecimal “26” is “00100101”, which would provide the wrong information regarding which fields are present in the message.

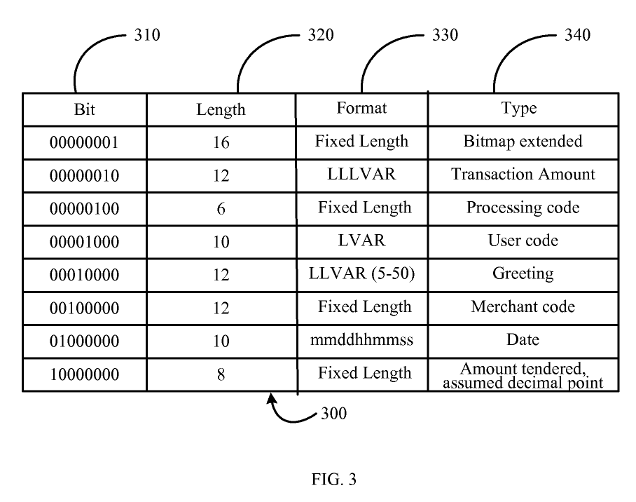

FIG. 3 shows an exemplary field dictionary 300, according to one embodiment of the invention. The field dictionary 300 includes four columns that correlate a bit representation 310 with the characteristics of the corresponding data element. These characteristics may include the length 320 of the data element, the format 330 (variable or fixed), and a description of the data element 340. Other information may also be present in the field dictionary and placed in various columns. In the field dictionary 300, the 5th data element has a maximum length of 12 and is variable as shown by “LLVAR”. “LL” depicts the number of bytes used to represent the variable length of the data. For example, “LLVAR” represents that the first two bytes in the data element represent the length of the remaining data element. “LLLVAR” represents that the first three bytes in the data element represent the length of the remaining data element. The 7th data element has a fixed length of 10 and is also in the format of “mmddhhmmss”, where “mm” is two characters representing the month, “dd” is two characters representing a day, “hh” is two characters representing an hour, “mm” is two characters representing a minute, and “ss” is two characters representing a second. Accordingly, the system knows the length and characteristics of the data elements that are present as indicated by the bitmap.

As noted by the bitmap, there are two data elements 220, 230 in the data field 210. By reference to the field dictionary 300 the first data element 220 (data element 5) is a variable length data element. Returning to FIG. 2, the first byte 222 in the first data element 220 (data element 5) represents the length of the data element. Here the first byte 222 has a hexadecimal value of “F5”, so the first data element 220 includes 5 bytes of data after the first byte 222. The data portion 225 of the first data field 220 contains the following hexadecimal characters: “C8 C5 D3 D3 4F.” The second data element 230 has a fixed length of 10 and contains the following hexadecimal characters “F0 F1 F2 F0 F1 F0 F2 F0 F3 F7”.

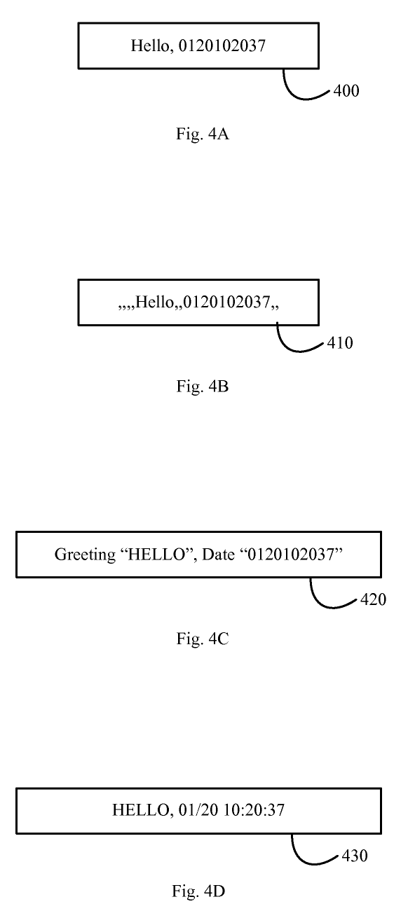

The first data element 220 in EBCDIC reads “H E L L O”, which is represented in ASCII as “48 45 4C 4C 4F”. A hexadecimal, decimal and ASCII conversion chart is shown in Appendix A and a conversion chart for hexadecimal, decimal, binary, ASCII, and EBCDIC is shown in Appendix C. The second data element 230 in EBCDIC displays as: “0120102037”, the ASCII representation of which is “30 31 32 30 31 30 32 30 33 37” in hexadecimal. As shown in FIG. 4A, a comma-delimited ASCII stream 400 may be created from the bitmap message: “HELLO, 0120102037”. If the original bitmapped data string 200 is converted straight to ASCII, the bitmap field 202-a becomes hexadecimal “26”, which is “00100110”. The bitmap indicates that three data elements are contained in data field 220, which would be data element 2, data element 3 and data element 6. By referring to the field dictionary 300, data element 2 is a variable length field which uses three bytes to indicate the data element length. The next three bytes in data field 210 are “F5 C8 C5”, which would indicate that the length of data element 2 should be 585 bytes. This value is derived from an EBCDIC convention is that is used to differentiate positive, negative and un-signed numbers. Positive numbers are represented in hexadecimal as “Cx”, negative numbers as “Dx” and un-signed numbers as “Fx”. Since there are not 585 bytes remaining in data field 210, an exception would occur.

In another embodiment of the invention, a comma delimits every possible data element location as shown by ASCII string 410 in FIG. 4B. Using the example in FIG. 2, the first four data elements are missing from the bitmap, so there is a comma for each missing field before the text “HELLO”. The next data element is also missing and would be represented by a corresponding comma. The element “0120102037” is present and is be separated from the next data element by a corresponding comma. Finally, data element 8 is missing from the bitmap, so there is an additional comma at the end of the ASCII string 410.

In another embodiment of the invention, the translated message may include data element type information. For example, as shown in FIG. 4C, the translated message 420 includes a data type designator from the field dictionary 300 and returns the translated message: “Greeting ‘HELLO’, Date ‘0120102037’”. Formatting may also occur during data string translation. For example, as shown in FIG. 4D, the date portion of the second data element 230 may use the format portion 330 of the field dictionary 300 to format the ASCII data string 430 and return the following: “HELLO, 01/20 10:20:37”. Various other formatting techniques may also be included in the translation.

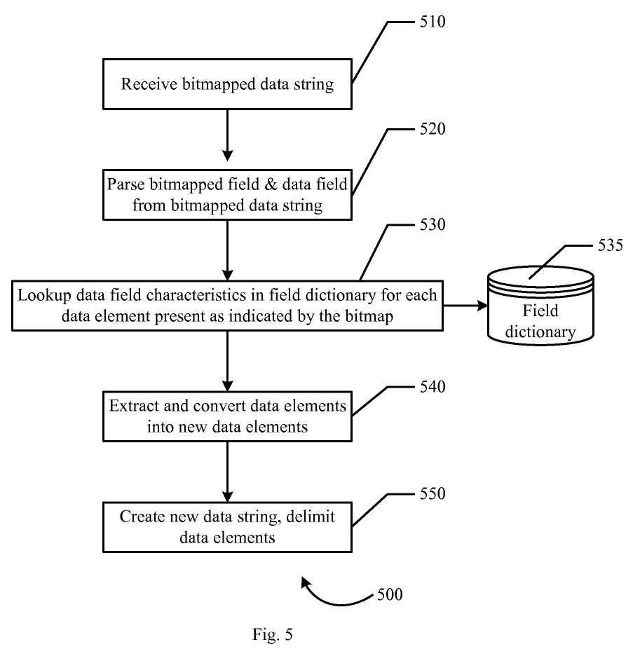

FIG. 5 shows a method 500 for converting a bitmapped data string into a new data string according to one embodiment of the invention. A bitmapped data string is received at block 510. The bitmap field and the data field are parsed at block 520. The bitmap field indicates whether a specific data element is present. The characteristics of each data element may be determined at block 530 by reference to the field dictionary 535. Data element characteristics may include format, length and data type. Once these characteristics are known, data elements may be extracted and converted at block 540. A new data string may be created with the elements delimited at block 550, for example, with commas. Every field may be delimited with a comma, whether the field is present in the data string or not.

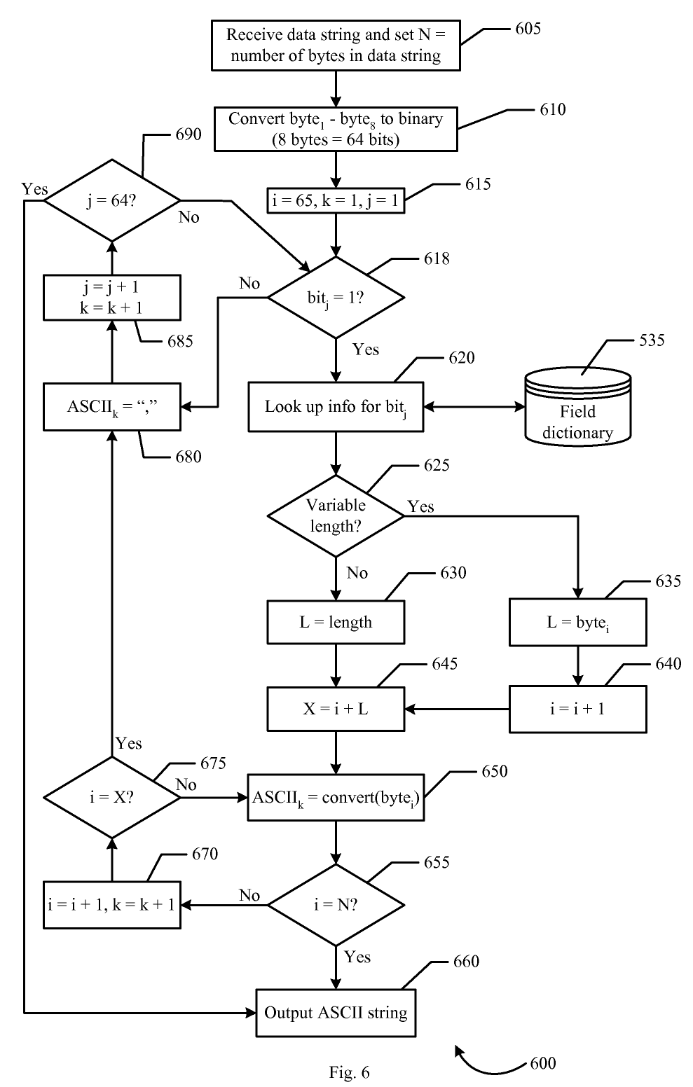

FIG. 6 shows a method 600 for converting a bitmapped data string into an ASCII data string according to one embodiment of the invention. A bitmapped data string is received and the value N is set to the number of bytes in the data string 605. The first eight bytes (byte₁ through byte₈) is the bitmap field. At block 610, the binary representation of the bitmap field is formed. The ASCII data string counter, k, the bitmapped data string byte counter, i, and the binary bitmap bit counter, j, are each initialized: k=1, i=65, and j=1, at block 615. In this embodiment, the bitmap field in the bitmapped data string is 8 bytes long. The bitmap field may be any size and the bitmapped data string byte counter, i, is initialized as one more than the number of bits in the bitmap field. Often the bitmap field is 8 to 16 bytes in length.

The system then determines whether the j^{th} bit in the binary bitmap field is equal to one (bitⱼ=1) at block 618 indicating the presence of a specific data element within the data field. In some embodiments, the binary bitmap field is read from right to left, such that, the first bit is the right most bit. If the j^{th} bit is equal to zero (bitⱼ=0) at block 618, then a comma is placed in the ASCII data field at the position pointed to by the ASCII data string counter, k, at block 680. The binary bitmap bit counter, j, and the ASCII data string counter, k, are then incremented at block 685. Whereupon the system determines whether every bit in the binary bitmap has been read at block 690, and if so, the ASCII string is output at block 660; otherwise the system determines whether the next bit in the binary bitmap string is equal to one (bitⱼ=1) at block 618.

If the next bit in the binary bitmap is equal to one, then information on the data element corresponding to j^{th} bit in the binary bitmap string is pulled at block 620 from the field dictionary 535. The length of the data element, at a minimum, is retrieved. If the field dictionary 535 indicates that the length of the data element is variable at block 625, then L is set to the value in the next byte in the bitmapped data string (L=byteᵢ) 635 and the bitmapped data string byte counter, i, is incremented at block 640. If the field dictionary 535 specifies the length of the data element, then L is set to the length of the data element as indicated by the field dictionary 535 at block 630. The endpoint of the data element in the bitmapped data string is then determined X=i+L at block 645. The k^{th} ASCII character in the new ASCII string is set equal to the ASCII conversion of the next byte in the data string (byteᵢ) at block 650. A conversion table from hexadecimal to ASCII is shown in Appendix A.

If the last converted byte (byteᵢ) was the last byte in the data string (i=N) at block 655, then the ASCII string is output at block 660. Otherwise, the bitmapped data string byte counter, i, and the ASCII data string counter, k, are incremented at block 670. If the last byte (byteᵢ) was not the last byte in the data element (i≠X) at block 675 then the system returns to block 650 and converts the next bitmap string byte into ASCII and places the converted byte in the ASCII data string. If, however, the last byte (byteᵢ) was the last byte in the data element (i=X) at block 675, and the last byte in the data element was converted at block 675, then a comma is entered as the next value in the ASCII string to delimit between data elements at block 680. The ASCII data string counter, k, and the binary bitmap bit counter, j, are each incremented at block 685. Information for the next data element present (bitⱼ=1 in block 618) is retrieved from the field dictionary 535 at block 620, and the cycle repeats until the entire bitmapped data string is converted to ASCII or when the bitmapped data string byte counter, i, equals the number of bytes in the bitmapped data string or when the binary bitmap bit counter, j, equals the number of bits in the binary bitmap string.

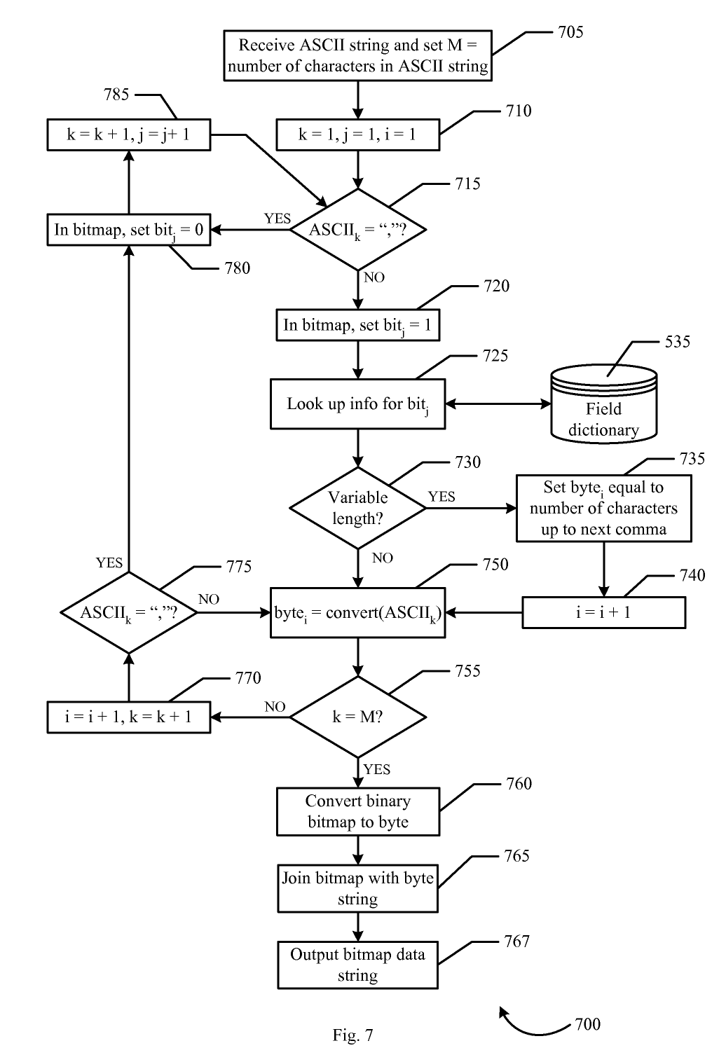

FIG. 7 shows a method 700 for converting a comma-delimited ASCII string into a bitmapped data string according to one embodiment of the invention. A comma-delimited ASCII string is received and the variable M is set to the number of characters in the comma-delimited ASCII string at block 705. The ASCII data string counter, k, the bitmapped data string byte counter, i, and the binary bitmap bit counter, j, are each initialized: k=1, i=1, and j=1, at block 710. The method then looks at the k^{th} character in the comma-delimited ASCII string and determines whether the k^{th} character is a comma at block 715. If the k^{th} character in the comma-delimited ASCII string is a comma, then the j^{th} bit in the binary bitmap is set equal to zero (bitⱼ=0) at block 780. The binary bitmap bit counter, j, and the ASCII data string counter, k, are incremented at block 785, whereupon the method looks at the next ASCII character at block 715.

If the k^{th} character in the comma-delimited ASCII string is not a comma, then the j^{th} bit in the binary bitmap is set equal to one (bitⱼ=1). Byte length information for the data element associated with the j^{th} data element is pulled from the field dictionary 535 at block 725. If the length of the j^{th} data element is variable at block 730, then the method sets the next byte (byteᵢ) in the bitmapped data field equal to the number of characters up to the next comma or the end of the comma-delimited data string at block 735. The bitmapped data string byte counter is then incremented at block 740. The next byte (byteᵢ) is set equal to the next ASCII character (ASCIIₖ) converted into a byte at block 750. If, however, at block 730, the length of the data element is not variable, the method sets the next byte (byteᵢ) equal to the next ASCII character (ASCIIₖ) converted into a byte at block 750.

The method then determines whether the entire comma-delimited ASCII string has been traversed by seeing if the ASCII data string counter is equal to the length of the comma-delimited ASCII string at block 755 (k=M). If the comma-delimited ASCII string has been traversed, the binary bitmap is converted into a byte at block 760, the bitmap field and the data field are joined at block 765 and the bitmapped data string is output at block 767. However, if the method has not reached the end of the comma-delimited ASCII string, then the bitmapped data string counter, i, and the ASCII data string counter are both incremented at block 770. The method then determines if it has reached the end of the ASCII data element at block 775. If the end of the ASCII data element has not been reached at block 775, then the next byte in the bitmapped data string is set equal to the ASCII character in the comma-delimited ASCII converted into a byte at block 755. Otherwise, if the end of the ASCII data element is reached, then the next bitmap bit is set equal to zero (bitⱼ=0) at block 780, and ASCII data string counter, k, and the binary bitmap bit counter are both incremented at block 785. The method then determines whether the next character in the comma-delimited ASCII string is a comma and the method repeats until it reaches the end of the comma-delimited ASCII string.

In another embodiment of the invention, the bitmapped data string is an EBCDIC data string. In another embodiment, the bitmapped data string conforms with ISO 8583. In another embodiment of the invention, the bitmap field length varies and the length of the bitmap field depends on the first bit in the binary bitmap field. Different data types may also be used. For example, a decimal bitmap string may be converted to binary using embodiments of the invention. An ASCII bitmapped data string may be converted to a comma-delimited data string and vice versa.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure, for example, processes to handle exception conditions. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, data string passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

### Appendixes

Attached and incorporated into this application are three appendixes. These appendixes include detail on one or more embodiments of this disclosure. The scope of the disclosure should not be limited by the detail disclosed in the appendixes. Appendix A is a hexadecimal to ASCII conversion table. Appendix B is a table showing an exemplary field dictionary for an ISO 8583 message. Appendix C is a hexadecimal, decimal, binary, ASCII, and EBCDIC conversion table.

What is claimed is:

1. A computer system for translating a bitmapped data string into a new data string, wherein the bitmapped data string comprises a bitmap field and a data field comprising one or more data elements, the computer system comprising:
an electronic storage;
a network adapter; and
a processor, wherein the processor comprises:
instructions to parse the bitmap field from the bitmapped data string;
instructions to determine from the bitmap field which data elements are present in the data field;
instructions to convert each of the at least one data elements into a new data element;
instructions to delimit each of the new data elements according to a new data string format associated with the new data string; and
instructions to create the new data string with each of the delimited new data elements.

2. The system of claim 1, wherein the new data string is sent to a network through the network adapter.

3. The system of claim 1, wherein the bitmapped data string conforms with ISO 8583 standard.

4. The system of claim 1, wherein the new data string is a comma-delimited ASCII data string.

5. The system of claim 1, wherein the bitmapped data string is received from a network through the network adapter.

6. The system of claim 1, wherein the processor includes instructions to expand the bitmap field into bit representations.

7. The system of claim 1, further comprising a field dictionary stored in the electronic storage, wherein the processor includes instructions to lookup a data field length stored in the field dictionary.

8. The system of claim 7, wherein
the field dictionary for a specific data element indicates that the data element length is variable and indicates the number of characters in the specific data element used to indicate the data element length; and
the processor comprises instructions to read the data element length from the number of characters in the specific data element, and converts the remainder of the element into a new data element.

9. A method for translating a bitmapped data string into a new data string, wherein the bitmapped data string comprises a bitmap field and a data field comprising one or more data elements, the method comprising:
parsing the bitmap field from the bitmapped data string;
determining from the bitmap field which of the at least one data elements are present in the data field;
converting each of the at least one data elements into a new data element;
delimiting each of the new data elements according to a new data string format associated with the new data string; and
creating the new data string with each of the delimited new data elements.

10. The method of claim 9, further comprising expanding the bitmap field into bit representations.

11. The method of claim 9, further comprising determining the length of each data element.

12. The method of claim 9, further comprising looking up data field characteristics in a data field dictionary.

13. The method of claim 9, further comprising receiving the bitmapped data string prior to removing the bitmap field from the bitmapped data string.

14. The method of claim 9, wherein the new data string format is a comma-delimited ASCII data string.

15. The method of claim 14, wherein empty data elements in the bitmapped data string are translated into empty data fields in the comma-delimited ASCII data string.

16. The method of claim 9, wherein the bitmapped data string is an ISO 8583 compliant data string.

17. The method of claim 9, wherein the new data string is a data stream.

18. A method for translating a data string into a bitmapped data string, wherein the data string comprises one or more data elements, the method comprising:
extracting data elements from the data string;
looking up in a data field dictionary the bitmap representation for the data element;
creating a bitmap field by setting the data bits relating to the data element according to the data field dictionary;
converting each of the at least one data elements into a new data element in the format associated with the bitmapped data string; and
joining the new data element and the bitmap field.

19. The method of claim 18, further comprising receiving the data string.

20. The method of claim 18, wherein the bitmapped data string is an ISO 8583 compliant data string.

21. The method of claim 18, wherein the new data string format is a comma-delimited ASCII data string.
